(19) United States
(12) Patent Application Publication
(10) Pub. No.: US 2021/0334116 A1
(43) Pub. Date: Oct. 28, 2021

(54) ARTIFICIALLY INTELLIGENT REQUEST AND SUGGESTION CARD

(71) Applicant: MeetKai, Inc., Marina Del Rey, CA (US)

(72) Inventor: James Kaplan, Marina Del Rey, CA (US)

(21) Appl. No.: 17/242,094

(22) Filed: Apr. 27, 2021

Related U.S. Application Data
(60) Provisional application No. 63/016,244, filed on Apr. 27, 2020.

(51) Int. Cl. G06F 9/451; G06N 5/04; G06F 3/0482

(52) U.S. Cl. CPC G06F 9/451; G06F 3/0482; G06N 5/04

(57) ABSTRACT

A method and system for generating artificial intelligence-driven user interface cards. The system includes non-transitory machine executable code configured to modify a smart card bundle to be compatible with the user device. The smart card bundle includes a first set of display elements and a first set of context data. The first set of display elements uses one or more functions provided by the user application and the first set of context data is responsive to a first request by a user. The machine executable code is further configured to predict user preferences based on analysis of user information, and to configure the smart card bundle based on the prediction. A second set of display elements and a second set of context data may also be to the smart card bundle, where the second set of display elements using a function not provided by the user application.

### CROSS-REFERENCE TO RELATED APPLICATION

This application claims priority to, and incorporates by reference, U.S. Provisional Application No. 63/016,244, which was filed on Apr. 27, 2020.

### FIELD OF INVENTION

The invention relates to providing an improved user interface to pair with an artificial intelligent (“AI”) virtual assistant, and in particular a visual display card system and method for bi-directional interaction with a user.

### BACKGROUND OF INVENTION

FIG. 1 illustrates a prior art user application interaction with the backend server to generate a static card. A user 104 interacts with a user device 108 (as defined in the glossary), or any user application (as defined in the glossary) on the user device, which then interacts with a backend server 112. The user request, which may be an active input (such as entering a voice command), or a passive action (such as opening a user application or a feature page in the user application), is processed 116 into a card request, which is then sent to the backend server 112. The backend server 112 responds to the card request by returning a static card, which is converted to static card primitives 120. Static card primitives are fundamental datatypes that cannot be broken down into simpler datatypes, such as integers, strings, Booleans. The static card primitives are then processed by a templating engine 120, which selects a pre-defined template from a set of pre-defined templates and styles to render based on the specifications in the static card. The prior art may also have a fallback mode for when the card versions are mismatched. For example, if the template engine 124 did not contain the corresponding native display implementation for the provided static card, the fallback engine 128 is triggered to output an error, which may cause the user 104 to experience an undefined behavior (such as an error message or a default template that does not correspond to any static cards).

Current cards are structured such that the rendering and the backend server are tied together in a specific version grouping. In this method, the user application is running on version X and can only connect to the backend server to power version X. The user application makes requests to the backend server assuming that all results are possible to be rendered on the device for the user to interact with. This works well in scenarios where the user application has a fixed amount of interactions. However, in any software providing AI services (as defined in the glossary) there are potentially infinite possibilities. With such a situation, the user application is forced to implement a fallback mode such that if the backend server returns a result to the user device, as part of an unexpected request, then the user application should not crash. To avoid this, the backend server is not capable of including new functionality without corresponding application updates. Furthermore, it is not possible for external developers to create custom skills that have a fully custom user interface, instead they are confined to be within what can be rendered in a very general scenario.

Finally, the interfaces are constrained into being purely display based logic. As a result, this means that it is not possible to have dynamic and customizable cards. Likewise, because the prior art lacks deep logic capabilities, it is not possible or efficient to build another level of AI into the cards themselves, such as suggesting further actions the user may take or adaptive layout to suit the user's desires. In the prior art, it is only possible to display a statically rendered card in such a way that if two users receive the same base result, they will observe the same base display. A statically rendered card means that two users who ask the same query will receive the exact same information and result. This makes it impossible to do tasks such as, but not limited to, restructuring the data display order or the image selection in order to boost engagement. Furthermore, suggestions for follow up tasks must be made outside of the current context in a much more generic format.

### SUMMARY

To overcome the drawbacks of the prior art and to provide additional benefits, a system for generating artificial intelligence-driven user interface cards is disclosed. In one embodiment, this system includes a first user device having a screen, a memory storing non-transitory machine executable code, and a processor configured to execute the machine executable code. In this embodiment, the machine executable code is configured to modify a smart card bundle to be compatible with the first user device. The smart card bundle includes a first set of display elements and a first set of context data. The first set of display elements uses one or more functions provided by the user application and the first set of context data is responsive to a first request by a user. The machine executable code is further configured to predict user preferences based on analysis of user information, and to configure the smart card bundle based on the prediction. A second set of display elements and a second set of context data may also be to the smart card bundle, where the second set of display elements using a function not provided by the user application.

In another embodiment, the user information is selected from one or more of the following: user account information, user preference, prior user selections, user input, user web browser history, user communication, or auxiliary metadata. It is contemplated that the first set of display elements may include an interactive prompt to the user suggesting additional user action. In one embodiment, the system further includes a backend server, and the first set of display elements includes a display element that is periodically updated with data from the backend server. The data may be streamed from the backend server to the smart card bundle. The second set of display elements may also be configured to communicate with a second user device. It is also contemplated that a third set of display elements and a third set of context data may be added to the smart card bundle based on a second request by the user, such that the third set of context data is responsive to both the first and the second user request.

Also disclosed is a method for generating artificial intelligence-driven user interface cards, which includes the steps of receiving a first user request from a user application running on a user device, compiling a smart card bundle comprising a first set of display elements and a second set of display elements, the first set of display elements using one or more functions provided by the user application, the second set of display elements using a function not provided by the user application, predicting user preferences based on analysis of user information, configuring the smart card bundle based on the prediction, and displaying the first and second set of display elements on a screen of the user device.

The user information may be selected from one or more of the following: user account information, user preference, prior user selections, user input, user web browser history, user communication, or auxiliary metadata. In one embodiment, the smart card bundle may include a first set of context data, which is responsive to the first user request. The method may include the additional steps of receiving a second user request from the user application, updating the smart card bundle with a second set of context data, the second set of context data responsive to the first user request and the second user request, and configuring the smart card bundle based on the prediction and the second user request. In another embodiment, the method may include the additional steps of updating the first set of context data with new information streamed from a backend server.

It is also contemplated that smart card bundle may include an interactive prompt to a user suggesting additional action. The interactive prompt may be configured based on the predicted user preferences. In one embodiment, the smart card bundle may be configured by performing one or more of the following actions: adding a display element, removing a display element, resize a display element, or reorder two or more display elements.

Another system for generating artificial intelligence-driven user interface cards is disclosed, which includes a first user device having a screen, a memory storing a non-transitory machine executable code, and a processor configured to execute the machine executable code. The machine executable code is configured to process a smart card bundle into a first smart card for display on the first screen, where the smart card bundle includes a set of display elements and a set of context data. The machine executable code is also configured render the set of display elements on the first smart card using a function not provided by the first user device, and update the context data with data from a second user device.

In one embodiment, this system may also include a second smart card processed from the smart card bundle by the second user device and a third smart card processed from the smart card bundle by a third user device. In this embodiment, context data on the first user device may be updated with data from the second and third smart card.

It is contemplated that the first, second, and third smart cards may send data to each other in a peer-to-peer fashion, and the first smart card is elected as a host. In another embodiment, the data from the second user device is routed from the second user device to a backend server, then from the backend server to the first user device.

### GLOSSARY OF TERMS

AI services: AI services are services provided as procedures and methods to a program to accomplish artificial intelligence goals. Examples may include image modelling, text modelling, forecasting, planning, recommendations, search, speech processing, audio processing, audio generation, text generation, image generation, and many more.

Device: A device is any element running with a minimum of a network interface and a CPU. Optionally, an accelerator can be attached in the form of a GPU or other specialized hardware accelerator. This accelerator can speed up the computation of AI services.

Operating System (“OS”): An operating system is software that supports a computer's basic functions, such as scheduling tasks, executing applications, and controlling hardware. The operating system provides access to these functions to other software.

User Application: A user application is any software running on any user facing device such as mobile devices, smart watches, tablets, home speakers, wearable devices including smart rings, glasses, hearing aids, CarPlay devices, security cameras, webcams, televisions, projection screen monitors, sound bars, personal computers, headphones, earbuds, and laptop devices where a user can interact with touch, audio, visual, or passively.

AI virtual assistant: An AI virtual assistant is a user application that interacts, provides information to, or interfaces with a user on a device using AI services.

User Information: User information data generated by, or collected from the user, such as user data (for example, account information, location data, user preferences) and user history (for example, data on a user's previous interactions with a device or a user application, user interests, prior activities, prior web searches, prior visited web sites, location history, health information).

Auxiliary Metadata: Auxiliary metadata is any data that is not related to the user, such as current date, news, room temperature, weather condition.

Card (i.e., smart card): A card is the display mechanism which is populated by the information requested by a user. This card can be a combination of text information, suggestion information, video, and/or image. FIG. 8 shows a visual representation of what an exemplary card looks like. A smart card is capable of displaying unique information for each user.

This innovation improves over the prior art by creating a system in which a virtual assistant can be expanded with new functionality without requiring user application updates. As new functionality is added, the user application does not need to be upgraded to begin answering queries with those new functional responses. The invention improves over limitations in extensibility by outside, external developers experienced in the prior art by removing the requirements to use a fixed markup language as part of the result. This allows for integration of deep domain specific logic into the rendered items themselves. Furthermore, this invention improves over the prior art by enabling for dynamic results such that the backend server is communicated with directly from the user application rendering. This improvement allows for deployments of multi-user situations where the frontends in different user applications can interact with each other directly without having user applications handle such an integration. Finally, the invention improves over the prior art by including a logic AI engine within the scope of a smart card. This engine is capable of dynamically adjusting the smart card to boost user engagement as well as providing suggestions for the user to carry out both within the domain itself, related to the smart card itself, or potentially in a related domain. More specifically, it provides the mean with which a server-controlled AI can render elements on a smart card. Furthermore, this rendering allows for AI-driven suggestions to be made as part of the card itself.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### DESCRIPTION OF THE DRAWINGS

FIG. 1 illustrates a prior art user application interaction with the backend server to generate a static card.

FIG. 2 illustrates an example embodiment of a system to generate smart cards for a user application running on a user device.

FIG. 3 illustrates exemplary smart cards displayed to four different users based on a same user query.

FIG. 4 is an operational flow diagram illustrating an exemplary process for generating a smart card.

FIG. 5 illustrates the structure of the backend rendering framework.

FIG. 6 illustrates the structure of the user application rendering framework.

FIG. 7 illustrates the primitive conversion engine.

FIG. 8 illustrates the fallback canvas primitive.

FIG. 9 illustrates how a logic injection engine may generate different smart cards based on the same user request.

FIG. 10 illustrates how a logic injection engine may generate different user prompts based on the same user request.

FIG. 11 illustrates a smart card optimization system, which may achieve the post-render optimization.

FIG. 12 illustrates an exemplary stock market smart card with live data updates.

FIG. 13 illustrates the communication framework between a smart card and a backend server.

FIG. 14 illustrates an exemplary chess smart card where a user may play a real-time chess game with an AI backend server.

FIG. 15 illustrates how a smart card template may be uploaded to the smart card registry and identified as a top card.

FIG. 16A illustrates how each smart card may be customized to fit the display screen of the user device the smart card is rendered on in a card-to-card interaction.

FIG. 16B illustrates exemplary smart cards customized for different user devices.

FIG. 17 illustrates the card-to-card interaction across more than two smart cards.

FIG. 18 illustrates the election framework for determining the smart card to act as the host.

FIG. 19 illustrates an alternative multi-card communication framework using a backend server as the host.

FIG. 20 illustrates an example environment of use of the smart card system described herein.

FIG. 21 illustrates an example embodiment of a mobile device, also referred to as a user device which may or may not be mobile.

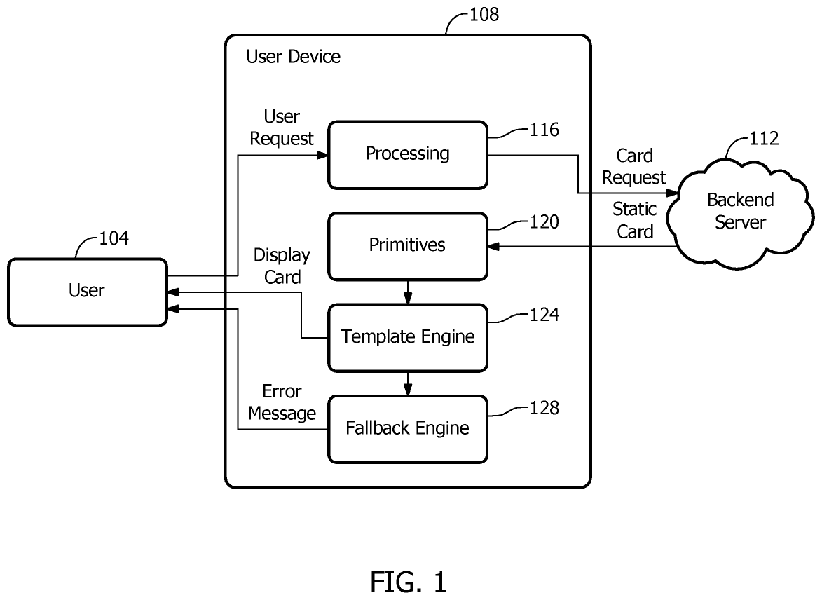

### DETAILED DESCRIPTION

The method and system to generate a smart card includes four key elements. The first element is the rendering framework, which is responsible for displaying a smart card. The second element is the smart card logic engine, which is responsible for implementing AI services on the smart card. The third element is the optimization system that makes externally developed smart cards compatible with the user application. The fourth element is the smart card communication framework, which allows for a plurality of smart cards to communicate with each other across user devices, and for a smart card to further communicate with the backend server directly.

More specifically, the rendering framework is composed of both a user application side and backend server implementation. In the backend server implementation, the rendering framework is responsible for injecting data and related metadata about and for the smart card into the context of the render request. Moreover, the backend server render must provide a hook for result driven AI such that the smart card can continue to perform intelligent tasks while it is being served to a user. A hook is a type of function allowing a base system to call on an extension code to permit changes or extensions of existing programs or systems. The user application implementation is responsible for translating the rendering from the server into native elements that can be displayed on the device. In different operating systems and platforms there may be different sets of primitive cards available for display. In the optimal case there may be native mappings for many of the primitive cards used, tables, graphs, grids, images and more. However, in the simplest case, the most minimum user application simply needs to provide a canvas to display a pre-rendered item. In this way, any device with a screen is capable of having a minimal user application rendering available.

The second key element is the smart card logic engine. The smart card logic engine is a framework that executes out AI tasks for the purposes of a more powerful display. These tasks can be related to any number of fields. Some example applications are for purposes of selecting the best image for a user to see on a smart card that is tailored to that particular user utilizing an AI selection engine based on numerous types of user data. The engine accomplishes this by running AI models to determine the optimal image given a user's past preferences or interaction level for images as well as other information about the user. This adaptive card intelligence feature is capable of customizing any component of the display using an intelligent engine based on user history and activity. It can remove detail sections if the AI engine determines it is not likely this particular user will read them or also introduce them if it is predicted that the user would be more likely to interact with the smart card if those details are included. This may be done automatically by the AI engine and it controlled by the user manually inputting their preferences into the system, although that optional manual override may be possible. Furthermore, the engine creating and powering the card is capable of including follow up suggestions and interactions with the user. Within the scope of a virtual assistant, these suggestions might be for follow-up tasks within the domain itself in a generic fashion (i.e., if the user is looking at weather information, then it may suggest asking for the weather tomorrow). These suggestions may also be in the form of, and/or related to more personalized items within the domain (i.e., if a user were looking at a movie, it might suggest that they ask about movies from a particular director if it is determined through the logic engine that a user is likely to do that or that it would be helpful to the user, such as if past movie watching habits are so that the user watches multiple movies from a particular director or with particular actors). Additionally, these suggestions could also be for follow ups in the context of other domains (i.e., such as if a user were looking at a book it might suggest asking for movies related to this same subject). All of these suggestions can be computed by the logic engine directly, by utilizing the context of the smart card that was injected by the backend server rendering engine from the first key element of this invention.

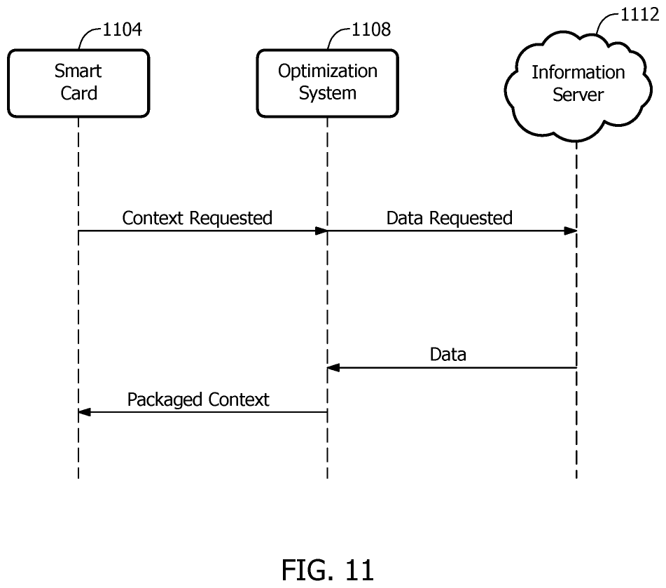

The third key element is the optimization system. This element is what allows for the inclusion of new types of smart cards without user application updates, and/or the inclusion of new display elements on smart cards that do not utilize functions native to the user application. This functionality will be discussed in more detail in FIGS. 11-14 below. This system is comprised of a protocol and a software development kit that are provided to simplify implementation of that protocol.

The protocol is comprised of a registration stage, a context injection stage, and a logic stage. In the registration stage the new smart card type must make itself known to the backend server rendering framework. Once this is completed then the backend server user application knows that it is capable of rendering that smart card. The backend server render aspects or sub-module of the user application can push this information to the user application either ahead of time, to prepare resources, or on as needed basis when the particular type of smart card first needs to be rendered.

In the context injection stage, the smart card defines what types of data it needs in order to fulfill its rendering requirements. This could mean injection of the context around the request for the smart card or related to the result that is being rendered as part of the smart card itself.

The final stage is the logic injection stage, in the logic injection stage the developer is able to encode program logic in the form of programming language instructions for determining the suggestions or other dynamic functionality that the logic engine should operate. These can be carried out in any programming language and can operate on any of the context injected by the previous stage. The update system is capable of managing multiple versions of the same type of smart card. Depending on the specifications of the user application device it selects the optimal version of the smart card to be sent to the user. These can be determined by various constraints of the device, such as the screen size, resolution, computing capabilities or network connection.

The other element (4th element) of the invention is the smart card communication framework. In the smart card communication framework hooks are provided to the smart card logic engine that allow for communication with external resources. In the simplest case, this can be communication with a backend server user application such that the card can update dynamically while the user is viewing it. This can be the case if there is video being live streamed, data being streamed (such as a stock price), or any other real time functionality. The more complex case is when multiple smart cards on different devices are interacting with one another. This can happen directly between cards on remote devices, in the case of an embedded video call or in any one-to-one communication. In the case where there are more than two smart cards that need to be connected the communication framework can elect a master card that acts as the server and the other cards connect to create a mesh. In the case that this election is unstable or fails, a backend server can be spawned to act as the remote master and communication can happen through it as a proxy.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

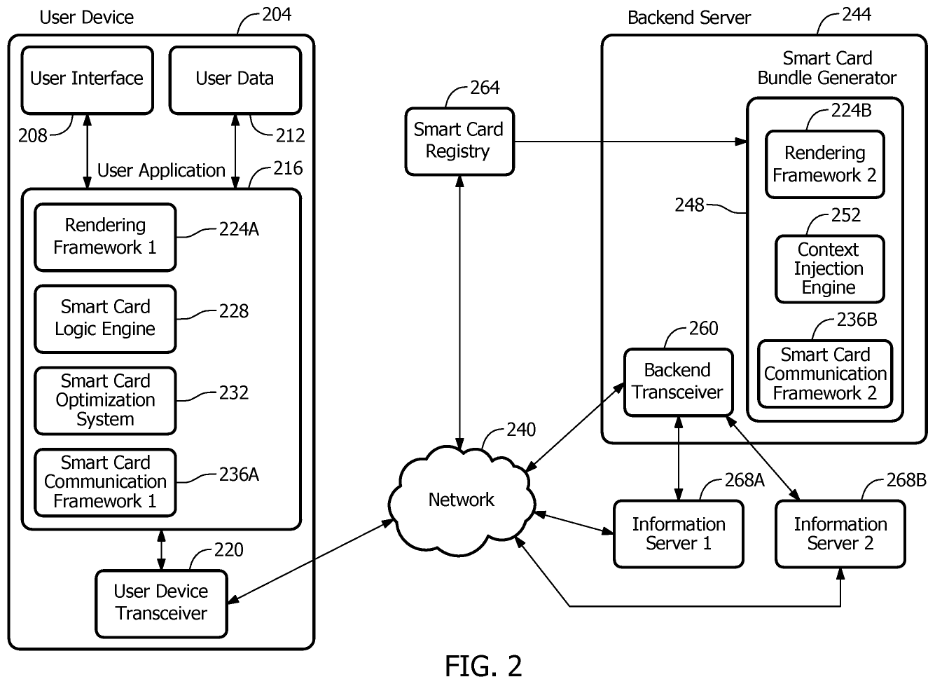

FIG. 2 illustrates an example embodiment of a system to generate smart cards for a user application running on a user device. In FIG. 2, a user device 204 provides user interface 208 such as display screens and user data 212 which may be stored on one or more memory devices. A user application with smart card capabilities 216 may run on the user device 204. The user device 204 may provide means for remote communication, such as a user device transceiver 220A, which the user application 216 may access and use. The user application 216 may include the four key elements discussed above: a first rendering framework 224A, a smart card logic engine 228, a smart card optimization system 232, and a first smart card communication framework 236A. Additional supporting software and hardware would be understood by one of ordinary skill in the art, and as such, is not described in detail herein.

The user device transceiver 220A may access any electronic communication network 240, such as local area network, a wide area network, a personal area network, the Internet, etc. Through the network 240, the user application 216 may access its backend server 244. The backend server 244 may include a smart card bundle generator 248, which further includes a second rendering framework 224B, a second smart card communication framework 236B, and a context injection engine 252. The backend server 244 may also include a backend transceiver 160 used to facilitate communication over the network 240.

The backend server 244 may, through the network 240, access a smart card registry 264, one or more information servers 168, and other devices or locations as described herein or as may be configured. The smart card registry 264 is one or more databases of cards that are available based on the domain of the card request. Domain is the topic that the card is based on. Examples of domains are stocks, recipes, restaurants, and other activities or user interest.

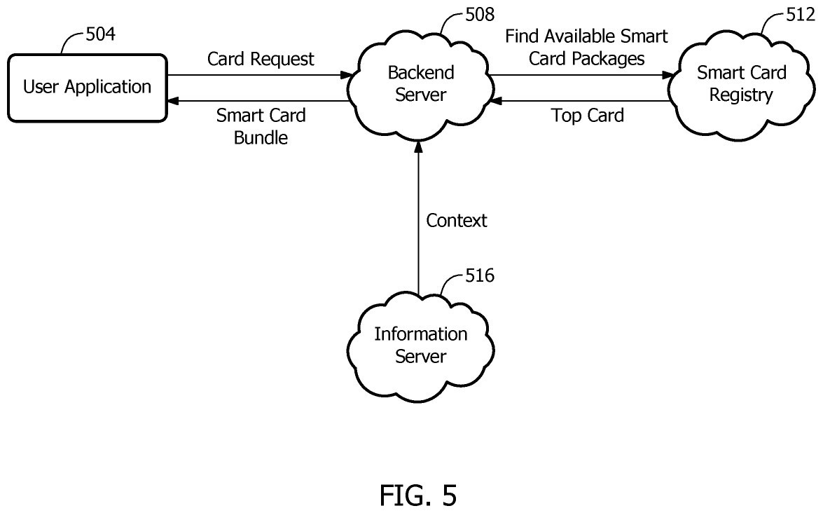

A smart card may be generated when the user application 216 sends a card request to the backend server 244. The backend server 244 may then search for a viable smart card in the smart card registry 264 and retrieve a top card. The top card is determined based on the domain and the user information stored on the backend server 244. This step will be discussed in more details in FIG. 5 below.

Upon retrieving an optimal smart card, the rendering frameworks 224 and the smart card communication frameworks 236 collaborate to generate a smart card format that is compatible for the user application 216 and the user device 204. The context injection engine 252 may retrieve context data (such as auxiliary metadata) from the information servers 268 to customize the optimal smart card to the user request. Based on the example domains listed above, the context may be stock prices, ingredients in a recipe, a list of restaurants, etc. A smart card bundle may be generated and returned to the user application 216 for further customization using the smart card logic engine 228. A smart card bundle is the top card with context from the one or more information servers 268. For example, where a card request is for the stock domain, a top card may be a card displaying three or more stocks based on the server-stored user information that this user likes to view three stocks at a time. The context may be the three last stocks the user last viewed on the user application 216.

Such customization may be based on user information such as user data 212 or user information from the information servers 268 which is processed using an AI engine to automatically customize the card for the user in a way that provides the user expected optimal information in the card and display of such information.

For example, the user application 216 may be a movie player, and the user request is a passive request of opening the user application 216, and the card request may be a request for a user interface displaying movies to the user. The optimal smart card may be a template for displaying movie information that provide the optimal information for the particular user in an optimal format for the particular user based on past history of that particular user and past interactions by the user with prior cards. Each user experience may be made different by the AI engine. The context may be a generic list of movie results for the user to choose from. Upon receiving the smart card bundle, the card logic engine 228 may, from the user data 212, determine the user's last viewed movie was only half-completed, and may move that last viewed movie title to the top of the displayed list. The card logic engine 228 may further determine, from the information servers 268, that the user history shows this user frequently searches for action movies and move action movie titles to the top of the displayed list. In addition, a web browser search history may show that the user is interested in cars and owns an old classic muscle car, and is interested in women's martial arts, and as such the card logic engine will show action movies that include classic muscle cars that include women in leading roles with martial arts fights.

In one embodiment, the user application 216 may also access the information servers 268 through the network 240 or a separate network for further smart card customization. Similarly, the backend server 244 may access the smart card registry 264 and/or the information servers 268 directly or through a separate network.

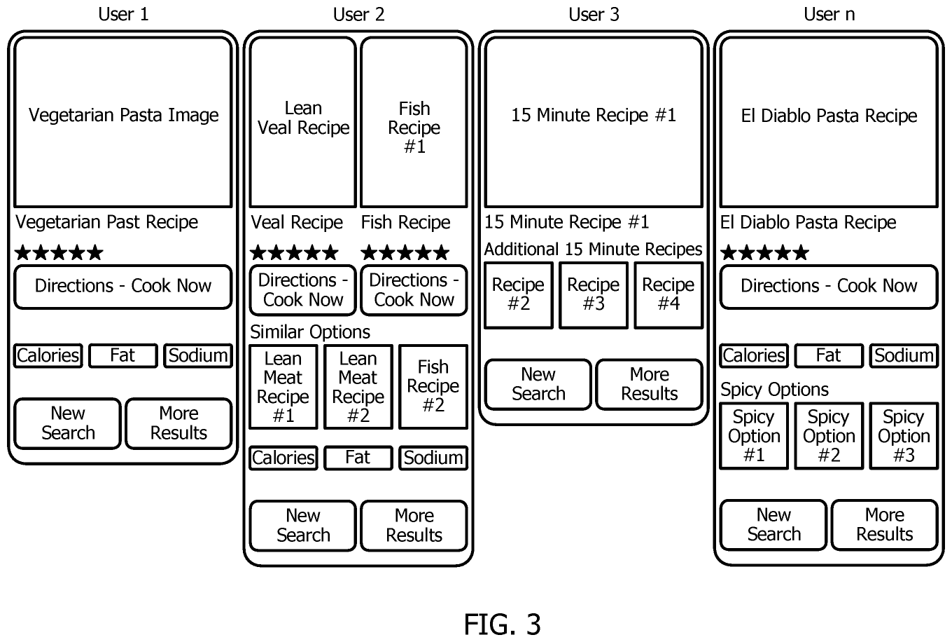

FIG. 3 illustrates exemplary smart cards displayed to four different users based on a same user query. In this example, the user application may be a recipe finder application, and four different users may have entered the same audio command request “find me an Italian recipe.” Upon returning the smart card bundle to the user application with a generic set of Italian recipes, as discussed in FIG. 2, the respective card logic engines in the recipe finder applications for the four users may, based on an analysis of the user data on the user device (such as the user's use history, interest, past activities, future activities, or user preferences) and/or the user data on information servers (such as the user's search history or view results), make the following determinations: a) user 1 is vegetarian and does not typically ask for a second follow up request; b) user 2 is on a diet, is not eating pasta, and typically needs more than one result to make a decision; c) user 3 is a parent, likes to cook simple and quick meals, and also likes to see more than one result at a time to show their children; and d) user n enjoys spicy food and typically asks for spicy recipes.

As a result, the same smart card bundle on the user application may be customized into vastly different smart cards for the four users: a) user 1 may receive a card with one vegetarian recipe without additional recipe recommendations; b) user 2 may receive two top recipes with lean proteins and three additional recommendations for recipes involving lean proteins; c) user 3 may receive one recipe with cook time under 15 minutes and three additional recommendations for recipes with cook times under 15 minutes, and because the recipes are determined to be for children to view, the nutrition facts label is removed; and d) user 4 may receive one recipe with spicy food and three additional recommendations for spicy food recipes. Each card is customized for the particular user to provide optimal information of interest for that user.

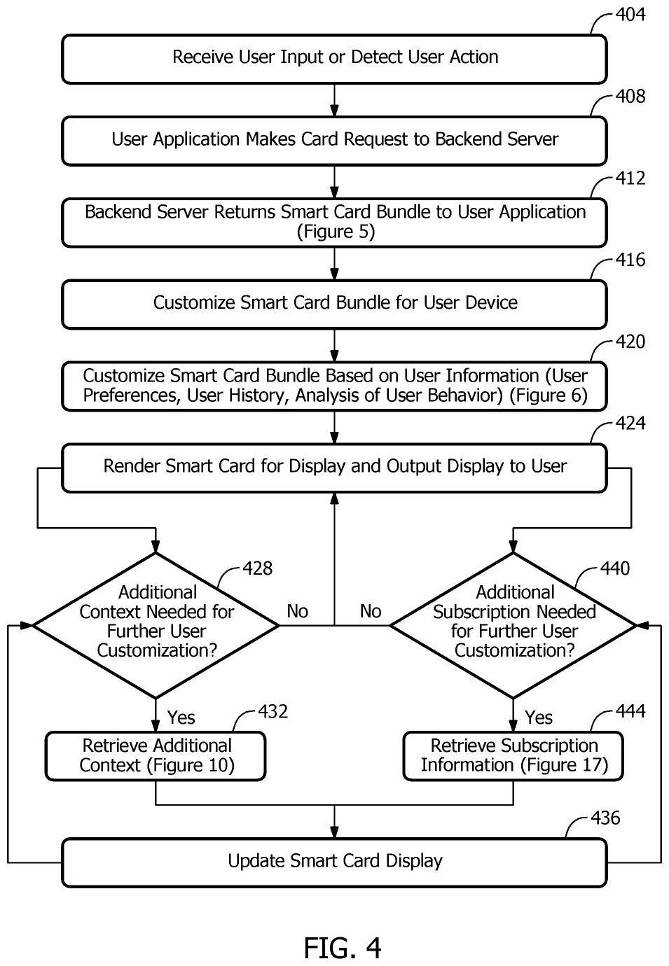

FIG. 4 is an operational flow diagram illustrating an exemplary process for generating a smart card. In a step 404, the user application or the user device receives a user request. As discussed above, the user request may be an active input (such as entering a voice command) or a passive action (such as opening a user application or a feature page in the user application). To generate a card responsive to the user request (such as a list of search results responsive to a user input for a search, or the main page of a user application responsive to the user's passive action of opening a user application), in a step 408, the user application may make a card request to the backend server. Upon receiving the card request, in a step 412, the backend server may return a smart card bundle to the user application. This step will be discussed in more details in FIG. 5.

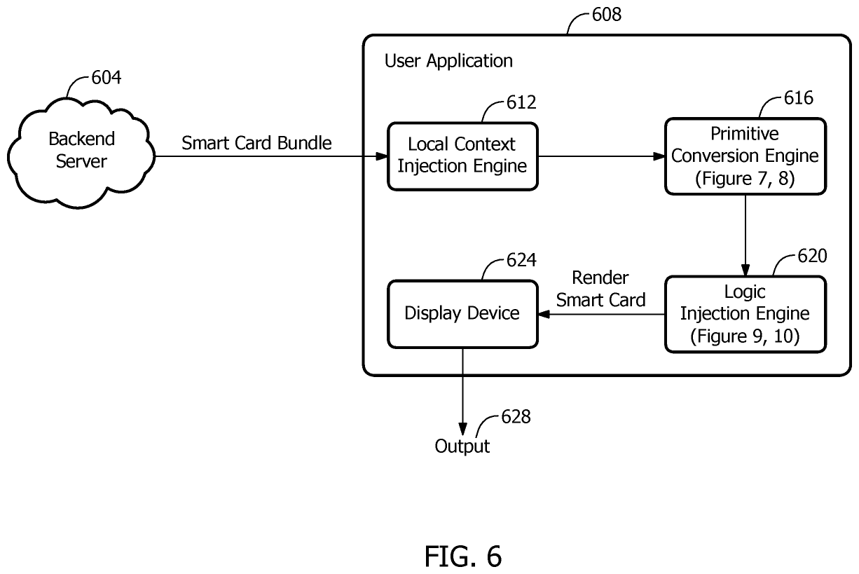

In a step 416, the smart card bundle may be customized for the user device the user application operates on, based on the user's devices' capabilities (phone type, screen size, battery life, etc.) and user settings (dark/light mode, brightness, location on/off, etc.). In a step 420, the smart card bundle is further customized based on the user information (as defined in the glossary, discussed in FIGS. 2 and 3, and discussed in more details in FIGS. 6-9).

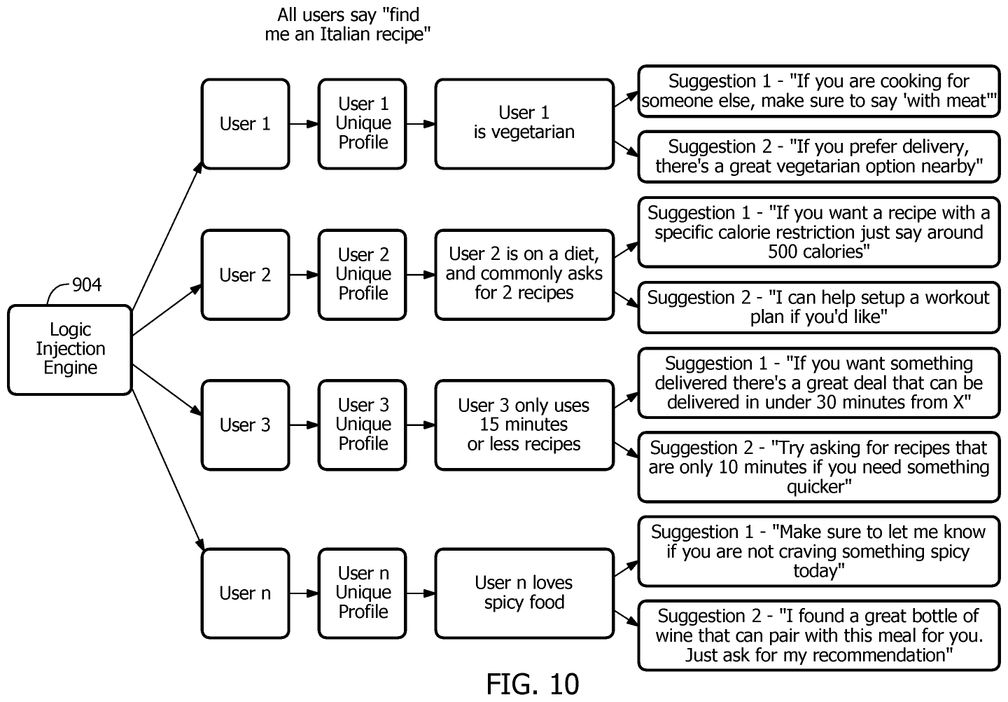

In a step 424, the smart card bundle is rendered based on steps 416 and 420 and displayed to the user. Upon display, the smart card maintains its ability for dynamic customization. In a step 428, the optimization system in the user application may determine whether additional context may be needed. This determination may be made continuously until the user's termination of the display of the smart card or made at set intervals to conserve resources. Using the example discussed above, where the user application is a recipe finder application, the smart card may have already displayed the top recipe selected for the user, but the optimization system has determined that the user requires additional recommendations. Thus, in a step 432, the optimization system may retrieve the additional context needed for further customization. The process of retrieving additional context is discussed in more details in FIG. 10. In a step 436, the smart card already in display, may be updated using the additional context retrieved.

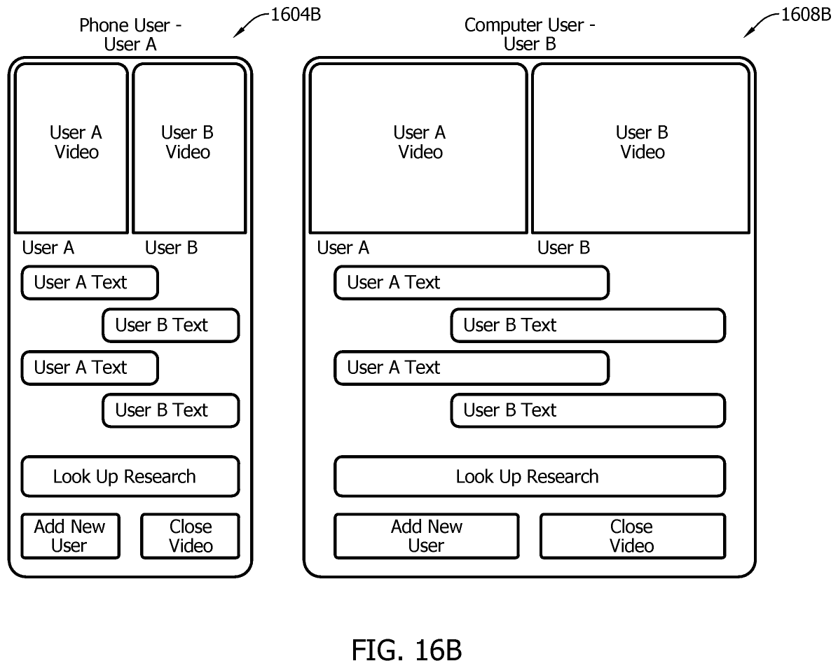

In a step 440, the optimization system in the user application may determine a subscription and on-going stream of data may be needed. This determination may be made continuously until the user's termination of the display of the smart card or made at set intervals to conserve resources. For example, if the user application is an online stock trading application, the optimization system may determine user requires real-time updates of stock values. Thus, in a step 444, the optimization system may retrieve the subscription data needed for further customization. The process of retrieving subscription data is discussed in more details in FIG. 17. In a step 436, the smart card already in display may be updated using the additional subscription data.

Where the smart card may be updated based on both additional context (steps 428-432) and subscription (steps 440-444), these updates may occur simultaneously or in sequence of either order (context first, or subscription first).

FIG. 5 illustrates the structure of the backend rendering framework. In FIG. 4, the user application 504 communicates with its backend server 508 using the methods described in FIG. 2. The backend server 508 in turn communicates with the smart card registry 512 and one or more information servers 516.

In response to a user request, the user application 504 may send a card request to the backend server 508. The card request may include the domain and various user-specified information. For example, where the user application 504 is a stock trading platform, and the user requested to view three specified stocks over the past 24 hours, the card request may include the domain (stock) and the user specification of three stocks in the past 24 hours.

In response to the card request, the backend server may search the smart card registry 512 for available smart card packages. Smart card packages are smart card templates with dynamic elements that may be dynamically modified based on an AI engine processing user data and automatically selecting an optimal template for the user and customizing the data within the template to create a customized user specific card. In the example above, where the card request is for a display of three stocks over the past 24 hours, the available smart card packages may include templates with at least three display elements for stock prices.

The backend server 508 may use available user information to select a top card.

For example, the backend server 508 may have user preferences stored to indicate the user only uses the user application 504 in dark mode and uses large fonts. The backend server 508 may thus select a top card with a dark template and large fonts. This process of selecting a top card based on user preferences and domain is the first layer of dynamic modification, which improves on the static cards in prior art that generally provides the same template for all users, with little to no modification based on unique user preferences].

The backend server 508 may use data from the information server 516 to inject context into the smart card package. Context from the information server 516 includes any data or information needed to populate the top card to produce a smart card responsive to the user request. For example, upon selecting the top card, the backend server 508 may then retrieve the stock prices of the last 24 hours for the three selected stocks and populate the three stock display elements with a visual display of the retrieved data. The AI engine may customize the card to the user. For example, if the user historically selects the stock performance to be plotted with the S&P 500 performance and for a one-year period, then the card presented to the user may be configured as such using past browsing history. Numerous other card customizations may occur through use of the AI engine having access to the user's history, activities, searches, location data, trading history, or any other user data.

The backend server 508 may then return a smart card bundle to the user application 504. The smart card bundle may include both the top card and the injected context. In the example above, the smart card bundle may include the three stock prices over the past 24 hours displayed on the dark card template with large font.

FIG. 6 illustrates the structure of the user application rendering framework. In continuation of FIG. 5, the smart card bundle is delivered from the backend server 604 to the user application 608, where the smart card bundle is further processed using a local context injection engine 612, a primitive conversion engine 616, a logic injection engine 620, and the display device 624, until a smart card is generated for output 628 to the user.

The local context injection engine 612 is a software module that is part of the user application which is configured to modify the smart card bundle based on local user application context data such as phone type (android vs. iOS), phone display (dark vs. light mode), screen size, battery life (full display vs. power-saving display).

The primitive conversion engine 616 optimizes the smart card bundle using whatever implementations are available on the device in order to achieve higher display performance and quality. For example, the primitive conversion engine 616 could convert a “map” item into a system specific implementation of interactive maps.

The logic injection engine 620 performs the next layer of dynamic modification of the smart card. Analyzing the user information on the user device, the user application 608, and any auxiliary metadata, the logic injection engine 620 reorders the display elements on the smart card bundle to best suit the user's needs and/or determines what information to include in the card based on analysis of past user preferences for the user, user history, and user actions/activities. For example, where the smart card bundle is the stock price charts of three stocks, stock A, B, C, over the last 24 hours, the logic injection engine 620 may determine the user is currently trading stock A (or researching, or working at, or passionate about), while watching stocks B and C. Thus, stock A may be displayed in a larger display window than stocks B and C, and may include visual indicators or alerts for stock price changes. The logic injection engine 620 may also determine stock C has shown a lot of volatility in the past 24 hours, while stock B has remained stable. Thus, the logic injection engine may rearrange stocks B and C to display stock C's chart before stock B's chart. The logic injection engine 620 is another improvement on the prior art, where static cards leave no room for further customization based on AI-detected user preferences and user history once a card is generated. Moreover, as shown in the example above, the smart cards are customizable not only as to the order of elements displayed. Rather, display parameters such as window size and the nature of the data itself may be customizable based on user needs. Moreover, a key improvement is the AI nature of such customization. While it is contemplated that a user may input specific requests for customization, the logic injection engine 620 may also perform such customization automatically and dynamically. The display device 624 renders the customized smart card bundle into a smart card for display, and outputs 628 the smart card to the user.

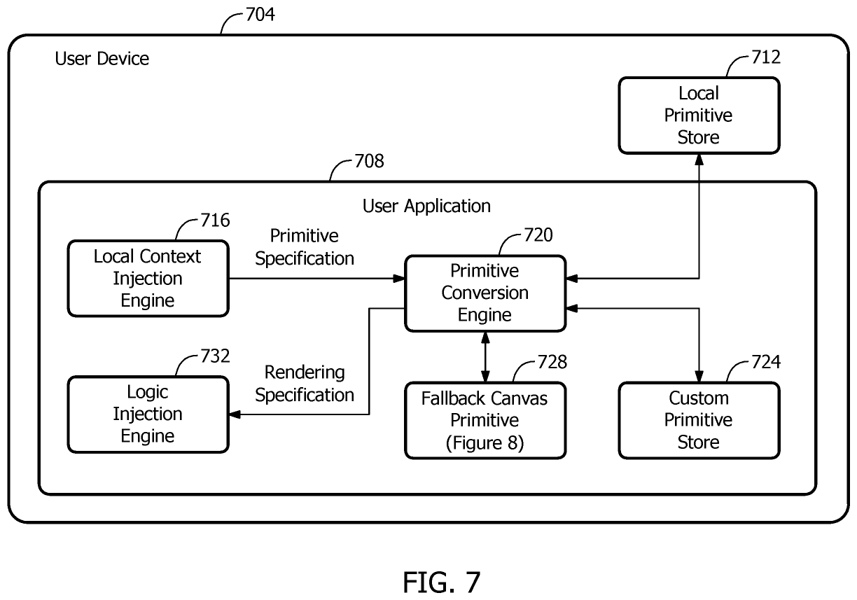

FIG. 7 illustrates the primitive conversion engine. In FIG. 7, a user device 704 contains a user application 708 and the local primitive store 712. The local primitive store 712 contains user interface elements that all user applications on the user device 704 may use. For example, all an iOS smartphone may contain user interface elements that all Apple^{TM} applications may use to look uniform, such as rounded corners for the display window, or a particular font or color scheme. The user application 708 includes, among others, the following elements: a local context injection engine 716, a primitive conversion engine 720, a custom primitive store 724, a fallback canvas primitive 728, and a logic injection engine 732.

As discussed in FIG. 6, a smart card bundle may first be processed by a local context injection engine 716. The local context injection engine 716 then sends the smart card bundle with primitive specifications to the primitive conversion engine 720. Primitive specifications are a set of definitions of the overall anticipated elements of the smart card with the local context (discussed in FIG. 6). For example, the smart card bundle may be a dark template with three display elements to show three stock prices over the last 24 hours and large font. The local context may be a card to fit the screen size of an iPhone 12. The primitive specification may be specifications for the <div>element, the <span> tag, etc. needed to render all the description above.

The primitive conversion engine combines the primitive specifications with native pre-implemented primitives to form a set of custom primitives that are extended in certain native user applications. Upon receiving the primitive specifications, the primitive conversion engine 720 may first search the local primitive store 712 for available user interface elements to fulfill the specifications. If the local primitive store 712 contains all the elements needed to fulfill the primitive specification, then the primitive conversion engine 720 may complete the processing and deliver rendering specifications to the logic injection engine 732. Rendering specifications are a set of specification needed to render the smart card bundle with the local context using the specified primitives. For example, a map application may first use natively implemented versions of maps and similar components to render a smart card of a map. In a preferred embodiment, elements in the local primitive store 712 are used first to optimize performance (including, but not limited to, increasing processing speed and conserving resources such as memory and battery life).

If the local primitive store 712 does not contain all needed elements, the primitive conversion engine 720 may next search the custom primitive store 724 for additional elements. The custom primitive store 724 contains user interface elements specifically provided by and for the user application 708. For example, a stock application may contain elements necessary for the display of stock pricing charts and tables. If the custom primitive store 724 contains all elements needed to fulfill the primitive specification, then the primitive conversion engine 720 may complete the processing and deliver rendering specifications to the logic injection engine 732.

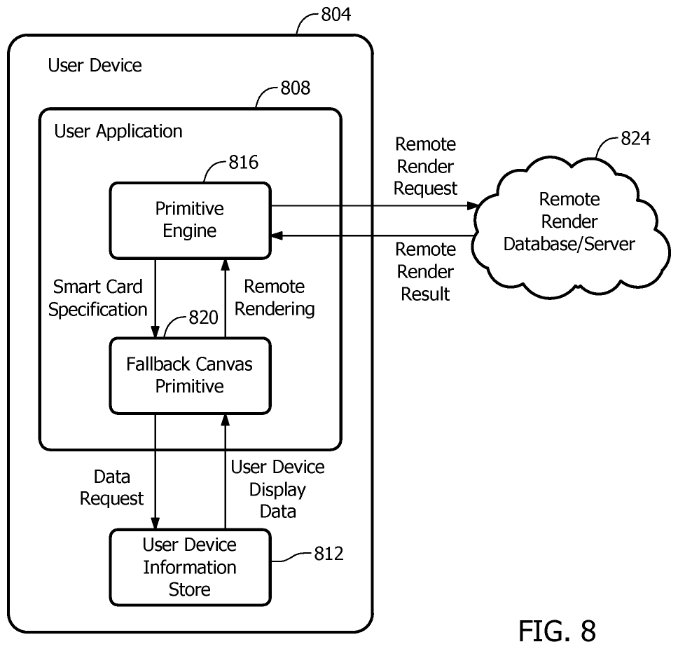

If, on the other hand, neither the local primitive store 712, nor the custom primitive store 724 contain all needed elements, the primitive conversion engine 720 may then utilize the fallback canvas primitives 728 to fill in the gaps and to ensure that the smart card can still be rendered on any user application. FIG. 8 contains a detailed discussion on how the fallback canvas primitive is used.

In another embodiment, the primitive conversion engine 720 may process the primitive specification using any combination of the local primitive store 712, the custom primitive store 724, and the fallback canvas primitives 728, and in any order.

FIG. 8 illustrates the fallback canvas primitive. In FIG. 8, a user device 804 includes a user application 808 and a device information store 812. The user application 808 includes a primitive engine 816 and a fallback canvas engine 820. The fallback canvas engine is connected to a render database, which may be stored in a cloud or remote cloud-based server 824. The render database may provide static rendering of card specifications.

As discussed in FIG. 7, the primitive engine 816 may use the fallback canvas primitive 820 to render the primitive specifications where no suitable primitives from the local primitive store or the custom primitive store may be available. In that case, the primitive engine 816 may send a set of smart card specifications to the fallback canvas primitive 820. The smart card specifications are parameters used for the rendering of a static card or static (non-interactable) elements on a smart card. The fallback canvas primitive 820 may trigger a remote request to the remote database 824 that is capable of providing a static rendering. The remote database 824 may return remote render results.

The fallback canvas primitive 820 may combine the remote render results with user device display data to generate the static card or static elements on a smart card. User device display data are data defining the user device's 804 display capabilities, such as number of pixels supported, pixel-intensity, black/white or color display, which may be obtained from the device information store 812. The static render may then be passed to the display device in the user application, as described in FIG. 6.

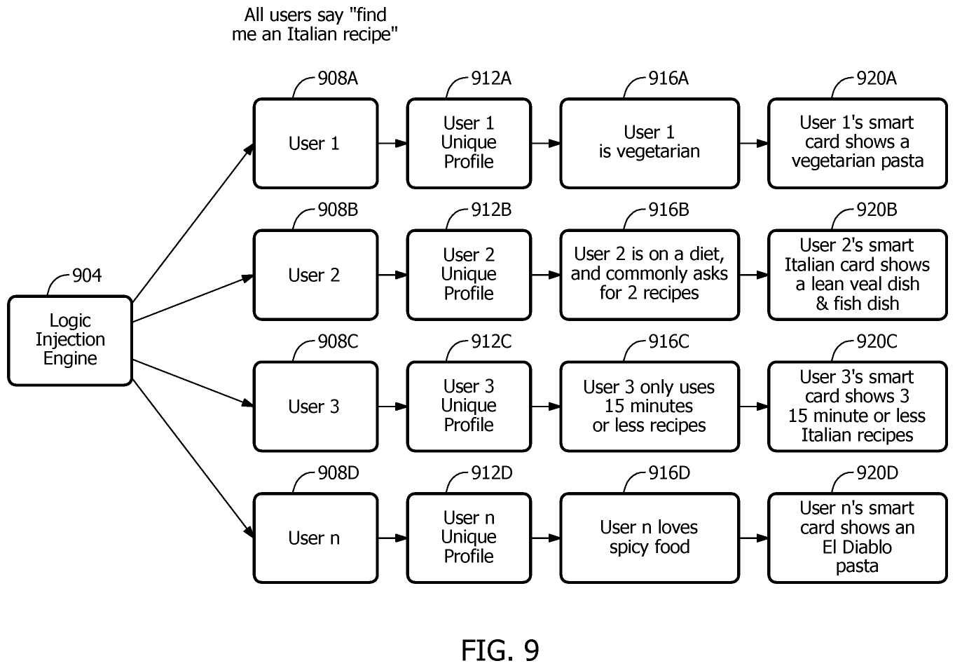

As discussed in FIG. 6, after a smart card bundle is processed by the primitive conversion engine, the logic injection engine may process the smart card bundle to further customize the smart card for the user. This step is an improvement on conventional cards, which contain minimal customization, and which may not rearrange elements, using an AI engine and user data, on the card to fit a user's unique needs. FIG. 3 illustrated an example of how four different users who input the audio command “find me an Italian recipe” may receive four different smart cards displays. FIG. 9 illustrates how the four different smart cards in FIG. 3 may be achieved using the logic injection engine 904. In a step 908, the logic injection engine 904 may first identify the user account making the user request. In a step 912, the unique user profile of the identified user account may be gathered. The unique user profile may include any user information (such as user account information, user history, user preferences) available on the user device, the user application, or any other connected devices, databases, or servers.

In a step 916, an analysis of the unique user profile may be performed to determine key user characteristics needed to customize the smart card. As discussed in the FIG. 3 example, the logic injection engine 904 may determine, in a step 916A, that user 1 is a vegetarian and does not typically ask for a second follow up request. The logic injection engine 904 may determine, in a step 916B, that user 2 is on a diet, is not eating pasta, and typically needs more than one result to make a decision. The logic injection engine 904 may determine, in a step 916C, that user 3 is a parent, likes to cook simple and quick meals, and also likes to see more than one result at a time to show their children. And the logic injection engine 904 may determine, in a step 916D, that user n enjoys spicy food and typically asks for spicy recipes. The determining step may be based on any number of factors by an AI engine that processes all data about the user to create a customized and unique experience to generate the card.

In a step 920, the smart card bundle may be customized based on the determination in step 916. For example, in a step 920A, the smart card for user 1 may be customized to show one vegetarian recipe without additional recipe recommendations. In a step 920B, the smart card for user 2 may be customized to show two top recipes with lean proteins and three additional recommendations for recipes involving lean proteins. In a step 920C, the smart card for user 3 may be customized to show one recipe with cook time under 15 minutes and three additional recommendations for recipes with cook times under 15 minutes, and because the recipes are determined to be for children to view, the nutrition facts label is removed. And in a step 920D, the smart card for user 4 may be customized to show one recipe with spicy food and three additional recommendations for spicy food recipes.

This level of customization, particularly the comprehensive gathering analysis of user information beyond use history in the user application, and the variety of customized, user specific card elements used to fit the need of individual users, may not be achieved with the conventional method of rendering static cards.

FIG. 10 illustrates how the four different smart cards in FIG. 3 may be further customized with user-specific prompts. Continuing the steps in FIG. 9, and based on the same determination of unique user profiles, each user may receive prompts for alternative recipe types (such as vegetarian vs. meat recipes), meal options (such as delivery), beverage recommendations, or further development of user interest (such as a prompt to set up a workout plan for user 2). As shown in FIG. 10, the content of the user-specific prompts may extend beyond the functionality and capability of the user application, which is a further improvement on the conventional method of rendering static cards, which may be limited to user-application-specific content. In contrast, the user-specific prompts in the smart card provide a unique user experience for each user to help guide and navigate the user to ask and receive better information that is custom to that specific user. Each time the user has a request, a completely new and unique prompt may be displayed on the smart card. This is only possible through AI services capable of analyzing past and current context to determine a user's preferences, likes, and dislikes.

If a user responds to these unique prompts, then the smart card may need post-render optimization. For example, as shown in FIG. 10, in response to suggestion 2 to user 1 for delivery of vegetarian food, user 1 may request for the suggested delivery. The smart card may then be updated with display responsive to user 1's follow-up request. This is another improvement from the conventional static cards, which may not be further updated or customized.

It should be apparent that a smart card, generated responsive to a card request by a user application, may initially be compiled with elements utilizing the functions of the user application. For example, a smart card generated for a recipe finder includes elements displaying recipes, a smart card generated for a movie streaming application includes elements displaying movie titles or a movie, a smart card generated for a stock trading platform includes elements displaying stocks, and so on. FIG. 11 illustrates the smart card optimization system, which may achieve the post-render optimization. For example, as discussed previously, the optimization system is one of the four key elements contributing to the dynamic customization of a smart card beyond the functionality of the user application. The optimization system may include a context injection engine that runs on a server capable of fetching data from data stores, which may be remote databases or servers capable of resolving auxiliary metadata requests.

In FIG. 11, a rendered smart card 1104 may be displayed on a user application or on the user device on which the user application runs. The user application may include an optimization system 1108. The optimization system 1108 may be in communication with one or more information servers 1112 via the various methods discussed in FIG. 2. Using the example discussed in FIG. 10, the user application may be a recipe finder application presenting a user with a unique prompt for delivery options. The delivery option itself may not be a feature the user application provides natively.

In response to a user request (which, as discussed above, may be a passive action, or an active input), the smart card 1104 may request additional context to update existing elements, or provide new elements, to display. The context request may be routed to the optimization system 1108, which processes the request to identify and obtain the additional data needed. For example, the context request in response to a user requesting delivery of vegetarian food may be to retrieve a list of available vegetarian restaurants within a 5-mile radius that offer delivery services.

Upon receiving the context request, the optimization system 1108 may request data to the one or more information servers 1112. In this example, the optimization system 1108 uses third party servers such as Google maps or Yelp to identify nearby vegetarian restaurants and additional information such as hours of operation, cost of delivery, and links to menus and online order forms.

Upon receiving the data, the optimization system 1108 may package the context into renderable specifications, which the smart card may display. As discussed above, the user application may not natively support delivery options (which may include the many features discussed above such as listing restaurants, retrieving menus, and displaying order forms). Conventional static cards may not have the ability to display elements not supported by the user application. In contrast, the smart card may generate elements displaying these features.

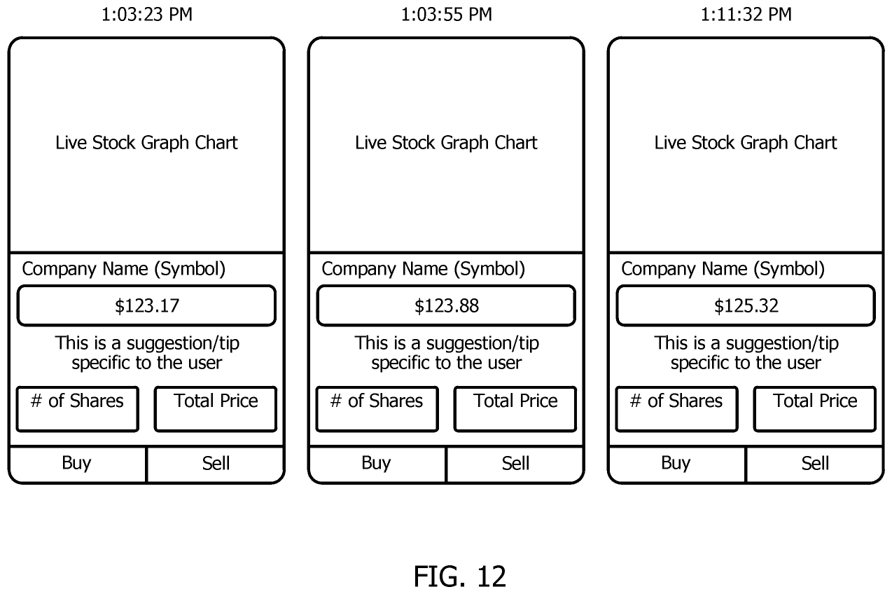

Another improvement from conventional static cards is the smart card's ability to update its display with live data based upon interaction with backend servers. FIG. 12 illustrates exemplary stock market smart cards with live data updates. In these examples, the smart card's data for stock prices update in real-time, which allows a trader to buy/sell through the smart card.

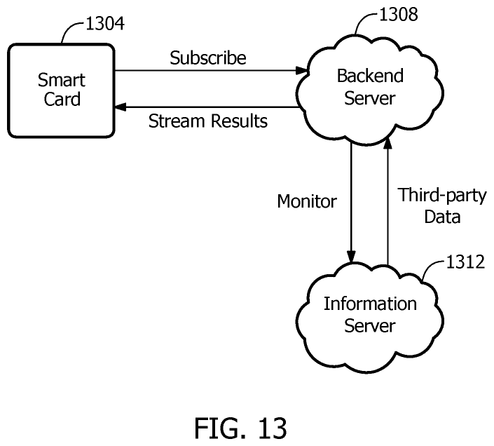

FIG. 13 illustrates the communication framework between a smart card and a backend server to demonstrate how the exemplary smart cards in FIG. 12 may be achieved. In FIG. 13, a smart card 1304 may communicate with a backend server 1308 using one of the methods discussed in FIG. 2. The backend server 1308 may communicate with one or more information servers 1312. Where the display on the smart card 1304 requires real-time updates, such as the changing stock prices in the exemplary smart cards in FIG. 12, the smart card may subscribe to the backend server to receive updates from the backend server to maintain the card in an updated state. A subscription is a request for a stream of results. A stream is a mode of communication where data is provided on an on-going basis. In the example of the stock market cards, the subscription would be for stock prices.

The backend server 1308 may, in turn, begin to monitor the one or more information servers 1312 for updates. In the example of the stock market cards, the information servers 1312 may be third-party websites displaying stock prices. The backend server 1308 may monitor these websites, and upon detecting changes in stock prices, stream such changes to the smart card 1304 and the price may be updated periodically regardless of any change.

In another embodiment, individual smart cards may monitor information servers and directly obtain third-party data. However, the embodiment of using a backend server is preferred because third-party data may require a subscription fee. The backend server may, with one subscription fee, service the subscription needs of any number of smart cards. In addition, where an individual smart card may go temporarily offline (such as due to bad signal reception on user devices), the backend server may continue to receive third-party data in real time, and retroactively stream the results to the smart card when the smart card is back online.

The smart card's ability to update its display with live data from the backend server extends beyond a simple stream of results. Smart cards may also interact with users in a turn-based fashion and maintain a state over several turns. A state is a collection of preceding events or user interactions at any point in time. Conventionally user-to-user application is turn-based only in the sense that a first user request yields a first response, and a second user request yields a second response, where the second response may only be responsive to the second request, but not responsive to the first request, because the state of the first request is not maintained. By integrating AI services to the smart cards and/or the backend servers, states can be maintained such that each new user request to an already-rendered smart card may be analyzed and processed in the context of previous user requests.

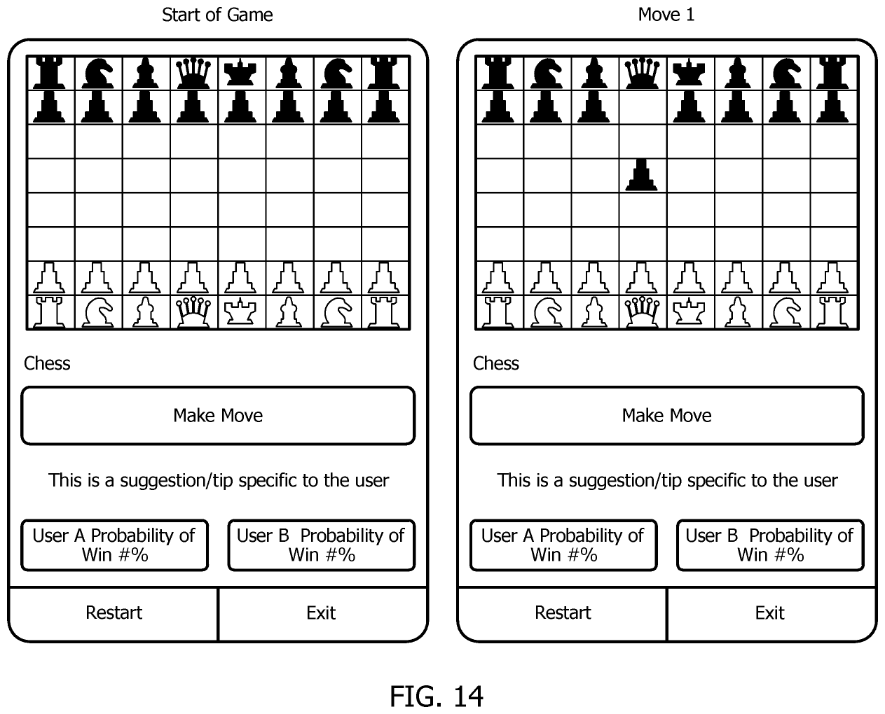

FIG. 14 illustrates exemplary chess smart cards where a user may play a real-time chess game with an AI backend server. The difference between the chess game in FIG. 14 and a chess game played in a conventional chess game user application is the chess game smart card in FIG. 14 may be displayed to the user in any user application. For example, a user may be viewing a recipe in a recipe finder application, but while waiting for water to boil, may request to play a chess game. The already-rendered smart card displaying the recipe may then incorporate an element for a chess game in the same card. In addition, the game play may occur within the card itself, and not require a separate program or software application dedicated to chess play.

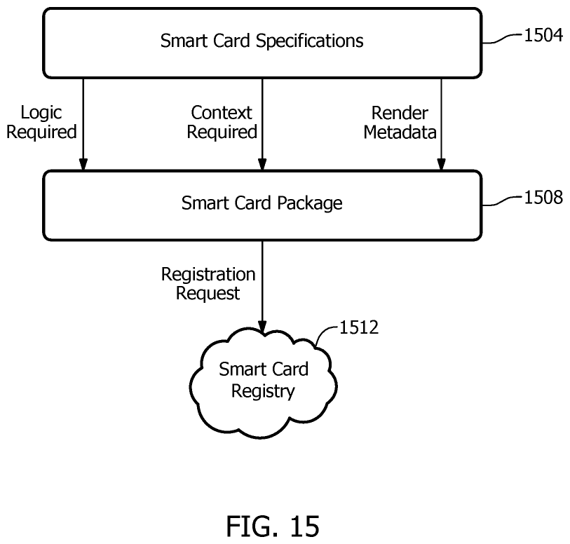

FIG. 15 illustrates how a smart card template may be uploaded to the smart card registry and identified as a top card. As discussed in FIGS. 2 and 5, in response to a card request, the smart card registry and the backend server work together to identify a top card responsive to the card request.

In FIG. 15, a smart card template is generated by providing a smart card specification 1504. The smart card specification 1504 defines the logic, context, and render metadata that the smart card bundle will request during rendering.

The logic request contains the program specifications for all logic and program routines as part of the code. This could be that the card requires capabilities to judge what actors a user likes more than others or what ranking they assign to certain genres.

The context required is the related metadata that needs to be fetched from external datastores as part of carrying out the render on the user application. An example might be that the card specification requires a list of the actors in a particular movie.

The render metadata is a definition of what user application information is needed in order to achieve the rendering process. This could be information on screen size or resolution and quality, as well as generic hardware device information.

The smart card specification 1504 is converted into a smart card package 1508 and sent to the smart card registry 1512 via a registration request.

The backend server searches for available smart card packages by identifying which set of smart card specification 1504 is most compatible with the user application and the user device. Upon finding the top card, the smart card registry delivers the smart card package 1508 to the backend server, which is then turned into a smart card bundle along with the injected context from information servers.

Another unique feature of smart cards is device-to-device communication through card-to-card interaction. Conventional static cards are unable to communicate with other static cards. Inter-device communication is typically achieved through external means such as user applications. Card-to-card interaction eliminates the user's need to download third-party applications for communication with another device or user. For example, users are conventionally forced to download a third-party application to participate in video conferencing (such as downloading Zoom or Microsoft Team). Smart cards, on the other hand, may facilitate video conferencing by simply rendering the display of a video and audio feed, thus eliminating the need for any third-party applications. Moreover, third-party applications are not universally compatible with all video screen devices such as mobile phones, computers, tablets, laptops, or televisions. Smart cards, on the other hand, may dynamically customize the display format and parameter to each different type of physical display screen and associated system.

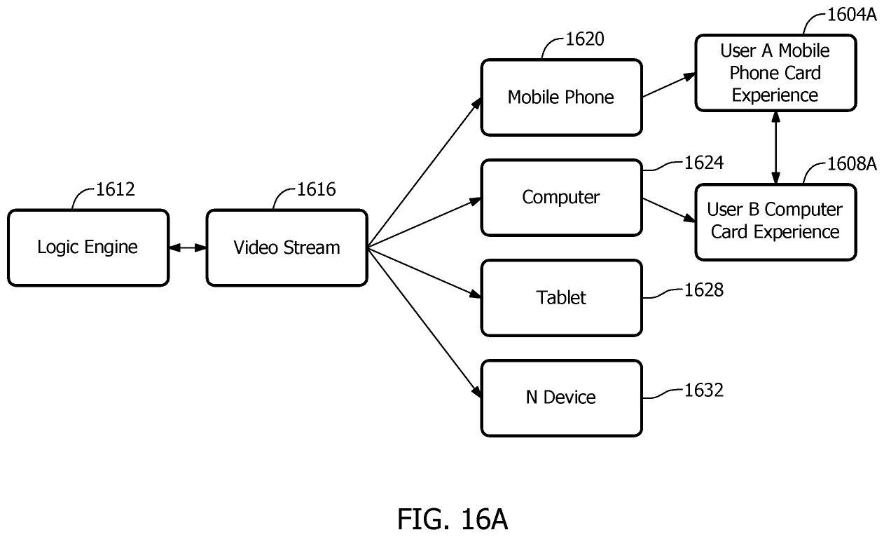

FIG. 16A illustrates how each smart card may be customized to fit the display screen of the user device the smart card is rendered on in a card-to-card interaction. In

FIG. 16A, the smart card of user A 1604A may interact with the smart card of user B 1608A, such as by displaying a video conference. Each smart card 1604A, 1608A has its own smart card logic engine 1612. As discussed above, the smart card logic engine 1612 is responsible for implementing AI services on the smart card. The respective smart card logic engine 1612 on user A and B's smart cards 1604A, 1608A may each identify the video screen device used to display the smart cards. In user A's case, the smart card logic engine 1612 may identify the video screen device as a mobile phone 1620 and customize the smart card 1604A to fit a phone screen. In user B's case, the smart card logic engine 1612 may identify the video screen device as a computer 1624 and customize the smart card 1608A to fit a computer screen.

FIG. 16B illustrates exemplary smart cards for users A and B. User A's smart card 1604B is customized for a phone screen, and user B's smart card 1608B is customized for a computer screen. Customization extends beyond cropping the screen to fit a different screen size. A comparison of the two smart cards 1604B, 1608B shows video display window may be entirely different (portrait vs. landscape). Additional display elements such as a text-based chat window may also be included.

FIGS. 16A and 16B illustrate one exemplary card-to-card interaction using video displays. It is contemplated that any type of card-to-card interaction may be achieved using smart cards. For example, users A and B may engage in a turn-based chess game by requesting a chess game display element on their smart cards, or review their selected stock prices side-by-side to compare their trades, or exchange their cooking recipes via smart cards.

It is also contemplated that the smart card experience may be further customized for each unique user. For example, the video conference on the smart card of user A 1604 may be full screen, meaning the video conference and the text-chased chat may be the only elements on the smart card. On the other hand, the video conference and chat box on the smart card of user B 1608 may be two of many other elements on a single smart card.

FIG. 17 illustrates the card-to-card interaction across more than two smart cards. Using the same methodology discussed in FIG. 16A, the smart card logic engine may customize the display of the same card to any user device including but not limited to mobile phones, computers, and tablets, while the smart cards on these devices interact with each other.

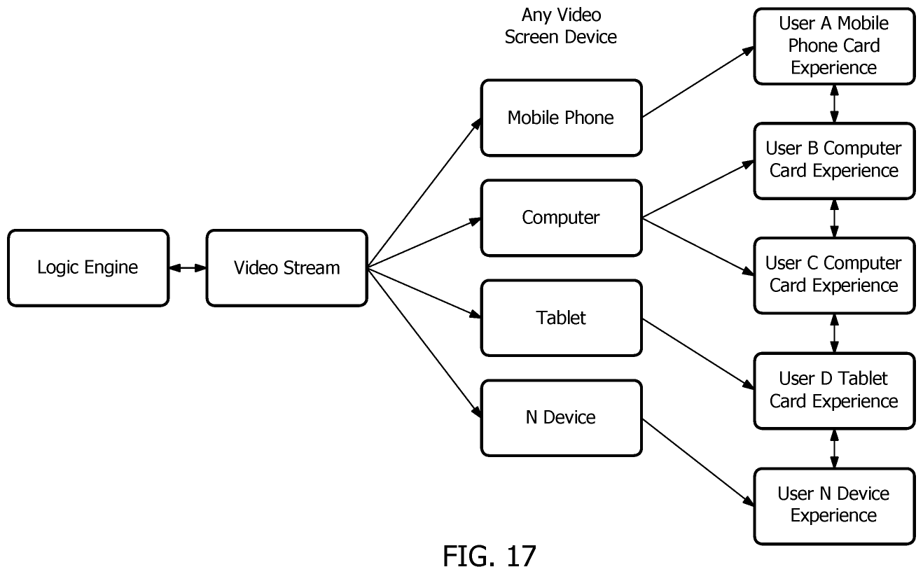

In multi-card interactions, one smart card may be elected as the host to ensure stability and synchronization of all cards. FIG. 18 illustrates the election framework for determining the smart card to act as the host. In FIG. 18, a first smart card 1804, a second smart card 1808, and a third smart card 1812 communicate with each other in round robin fashion to determine through a heuristic voting process which card is the most stable to act as the host. The host is selected based on the stability of the user device (available power, ability to process complex AI service requests, etc.) and the stability of their respective network connection (signal strength, bandwidth, etc.), or any other factor that may make the device suitable as a host. This election framework can be scaled from any number of smart cards greater than two on any number of devices. Stability is determined through executing the Raft consensus algorithm.

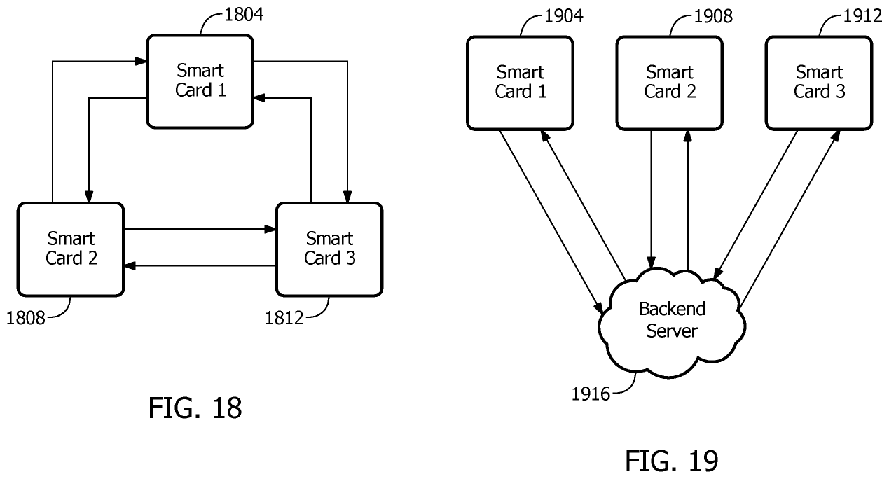

In another embodiment, a backend server may be used as the host. FIG. 19 illustrates this alternative multi-card communication framework. In FIG. 19, a first smart card 1904, a second smart card 1908, and a third smart card 1912 are in communication with each other through a backend server 1916. The backend server 1916 may be a remote server operating software capable of routing messages between various remote smart cards, user applications, or servers. The backend server 1916 may thus server as the host.

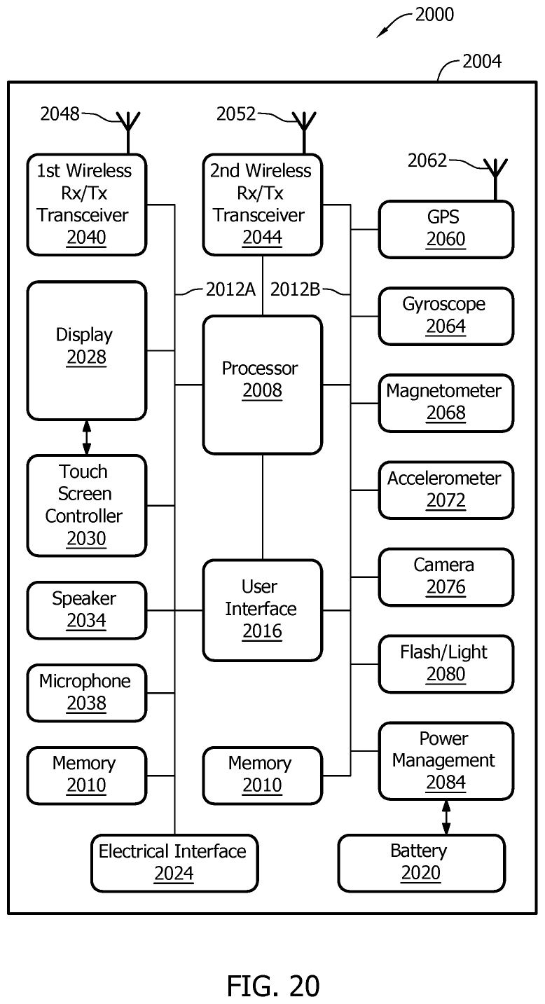

FIG. 20 illustrates an example embodiment of a mobile device 2000, also referred to as a user device which may or may not be mobile. This is but one possible mobile device configuration and as such it is contemplated that one of ordinary skill in the art may differently configure the mobile device. The mobile device 2000 may comprise any type of mobile communication device capable of performing as described below. The mobile device may comprise a PDA, cellular telephone, smart phone, tablet PC, wireless electronic pad, an IoT device, a “wearable” electronic device or any other computing device.

In this example embodiment, the mobile device 2000 is configured with an outer housing 2004 configured to protect and contain the components described below. Within the housing 2004 is a processor 2008 and a first and second bus 2012A, 2012B (collectively 2012). The processor 2008 communicates over the buses 2012 with the other components of the mobile device 2000. The processor 2008 may comprise any type processor or controller capable of performing as described herein. The processor 2008 may comprise a general purpose processor, ASIC, ARM, DSP, controller, or any other type processing device. The processor 2008 and other elements of the mobile device 2000 receive power from a battery 2020 or other power source. An electrical interface 2024 provides one or more electrical ports to electrically interface with the mobile device, such as with a second electronic device, computer, a medical device, or a power supply/charging device. The interface 2024 may comprise any type electrical interface or connector format.

One or more memories 2010 are part of the mobile device 2000 for storage of machine readable code for execution on the processor 2008 and for storage of data, such as image data, audio data, user data, location data, accelerometer data, or any other type of data. The memory 2010 may comprise RAM, ROM, flash memory, optical memory, or micro-drive memory. The machine readable code (software modules and/or routines) as described herein is non-transitory.

As part of this embodiment, the processor 2008 connects to a user interface 2016. The user interface 2016 may comprise any system or device configured to accept user input to control the mobile device. The user interface 2016 may comprise one or more of the following: microphone, keyboard, roller ball, buttons, wheels, pointer key, touch pad, and touch screen. A touch screen controller 2030 is also provided which interfaces through the bus 2012 and connects to a display 2028.

The display comprises any type display screen configured to display visual information to the user. The screen may comprise a LED, LCD, thin film transistor screen, OEL CSTN (color super twisted nematic), TFT (thin film transistor), TFD (thin film diode), OLED (organic light-emitting diode), AMOLED display (active-matrix organic light-emitting diode), capacitive touch screen, resistive touch screen or any combination of these technologies. The display 2028 receives signals from the processor 2008 and these signals are translated by the display into text and images as is understood in the art. The display 2028 may further comprise a display processor (not shown) or controller that interfaces with the processor 2008. The touch screen controller 2030 may comprise a module configured to receive signals from a touch screen which is overlaid on the display 2028.

Also, part of this exemplary mobile device is a speaker 2034 and microphone 2038. The speaker 2034 and microphone 2038 may be controlled by the processor 2008. The microphone 2038 is configured to receive and convert audio signals to electrical signals based on processor 2008 control. Likewise, the processor 2008 may activate the speaker 2034 to generate audio signals. These devices operate as is understood in the art and as such are not described in detail herein.

Also connected to one or more of the buses 2012 is a first wireless transceiver 2040 and a second wireless transceiver 2044, each of which connect to respective antennas 2048, 2052. The first and second transceiver 2040, 2044 are configured to receive incoming signals from a remote transmitter and perform analog frontend processing on the signals to generate analog baseband signals. The incoming signal may further be processed by conversion to a digital format, such as by an analog to digital converter, for subsequent processing by the processor 2008. Likewise, the first and second transceiver 2040, 2044 are configured to receive outgoing signals from the processor 2008, or another component of the mobile device 2008, and up convert these signals from baseband to RF frequency for transmission over the respective antenna 2048, 2052. Although shown with a first wireless transceiver 2040 and a second wireless transceiver 2044, it is contemplated that the mobile device 2000 may have only one such system or two or more transceivers. For example, some devices are tri-band or quad-band capable, or have Bluetooth®, NFC, or other communication capability.

It is contemplated that the mobile device, and hence the first wireless transceiver 2040 and a second wireless transceiver 2044 may be configured to operate according to any presently existing or future developed wireless standard including, but not limited to, Bluetooth, WI-FI such as IEEE 802.11 a,b,g,n, wireless LAN, WMAN, broadband fixed access, WiMAX, any cellular technology including CDMA, GSM, EDGE, 3G, 4G, 5G, TDMA, AMPS, FRS, GMRS, citizen band radio, VHF, AM, FM, and wireless USB.

Also, part of the mobile device is one or more systems connected to the second bus 2012B which also interface with the processor 2008. These devices include a global positioning system (GPS) module 2060 with associated antenna 2062. The GPS module 2060 is capable of receiving and processing signals from satellites or other transponders to generate location data regarding the location, direction of travel, and speed of the GPS module 2060. GPS is generally understood in the art and hence not described in detail herein. A gyroscope 2064 connects to the bus 2012B to generate and provide orientation data regarding the orientation of the mobile device 2004. A magnetometer 2068 is provided to provide directional information to the mobile device 2004. An accelerometer 2072 connects to the bus 2012B to provide information or data regarding shocks or forces experienced by the mobile device. In one configuration, the accelerometer 2072 and gyroscope 2064 generate and provide data to the processor 2008 to indicate a movement path and orientation of the mobile device.

One or more cameras (still, video, or both) 2076 are provided to capture image data for storage in the memory 2010 and/or for possible transmission over a wireless or wired link or for viewing at a later time. The one or more cameras 2076 may be configured to detect an image using visible light and/or near-infrared light. The cameras 2076 may also be configured to utilize image intensification, active illumination, or thermal vision to obtain images in dark environments. The processor 2008 may process machine readable code that is stored on the memory to perform the functions described herein.

A flasher and/or flashlight 2080, such as an LED light, are provided and are processor controllable. The flasher or flashlight 2080 may serve as a strobe or traditional flashlight. The flasher or flashlight 2080 may also be configured to emit near-infrared light. A power management module 2084 interfaces with or monitors the battery 2020 to manage power consumption, control battery charging, and provide supply voltages to the various devices which may require different power requirements.

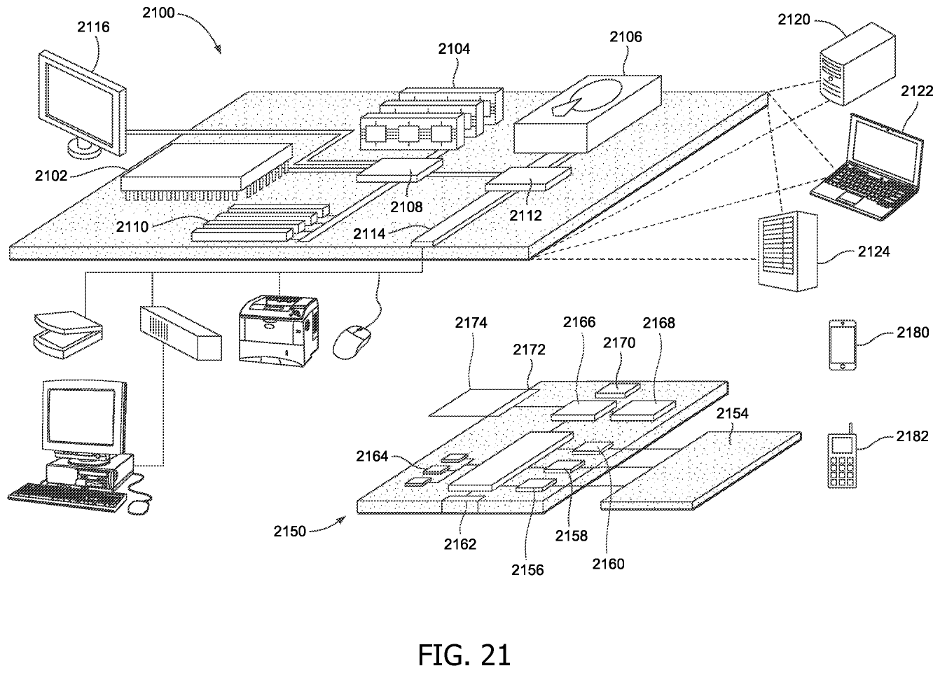

FIG. 21 is a schematic of a computing or mobile device, or server, such as one of the devices described above, according to one exemplary embodiment. Computing device 2100 is intended to represent various forms of digital computers, such as smartphones, tablets, kiosks, laptops, desktops, workstations, personal digital assistants, servers, blade servers, mainframes, and other appropriate computers. Computing device 2150 is intended to represent various forms of mobile devices, such as personal digital assistants, cellular telephones, smart phones, and other similar computing devices. The components shown here, their connections and relationships, and their functions, are meant to be exemplary only, and are not meant to limit the implementations described and/or claimed in this document.

Computing device 2100 includes a processor 2102, memory 2104, a storage device 2106, a high-speed interface or controller 2108 connecting to memory 2104 and high-speed expansion ports 2110, and a low-speed interface or controller 2112 connecting to low-speed bus 2114 and storage device 2106. Each of the components 2102, 2104, 2106, 2108, 2110, and 2112, are interconnected using various busses, and may be mounted on a common motherboard or in other manners as appropriate. The processor 2102 can process instructions for execution within the computing device 2100, including instructions stored in the memory 2104 or on the storage device 2106 to display graphical information for a GUI on an external input/output device, such as display 2116 coupled to high-speed controller 2108. In other implementations, multiple processors and/or multiple buses may be used, as appropriate, along with multiple memories and types of memory. Also, multiple computing devices 2100 may be connected, with each device providing portions of the necessary operations (e.g., as a server bank, a group of blade servers, or a multi-processor system).

The memory 2104 stores information within the computing device 2100. In one implementation, the memory 2104 is a volatile memory unit or units. In another implementation, the memory 2104 is a non-volatile memory unit or units. The memory 2104 may also be another form of computer-readable medium, such as a magnetic or optical disk.

The storage device 2106 is capable of providing mass storage for the computing device 2100. In one implementation, the storage device 2106 may be, or contain, a computer-readable medium such as a hard disk device, an optical disk device, or a tape device, a flash memory or other similar solid-state memory device, or an array of devices, including devices in a storage area network or other configurations. A computer program product can be tangibly embodied in an information carrier. The computer program product may also contain instructions that when executed, perform one or more methods such as those described above. The information carrier is a computer- or machine-readable medium such as the memory 2104, the storage device 2106, or memory on processor 2102.

The high-speed controller 2108 manages bandwidth-intensive operations for the computing device 2100, while the low-speed controller 2112 manages lower bandwidth-intensive operations. Such allocation of functions is exemplary only. In one implementation, the high-speed controller 2108 is coupled to memory 2104, display 2116 (e.g., through a graphics processor or accelerator), and to high-speed expansion ports 2110, which may accept various expansion cards (not shown). In the implementation, low-speed controller 2112 is coupled to storage device 2106 and low-speed bus 2114. The low-speed bus 2114, which may include various communication ports (e.g., USB, Bluetooth, Ethernet, wireless Ethernet) may be coupled to one or more input/output devices, such as a keyboard, a pointing device, a scanner, or a networking device such as a switch or router, (e.g., through a network adapter).

The computing device 2100 may be implemented in several different forms, as shown in the figure. For example, it may be implemented as a standard server 2120, or multiple times in a group of such servers. It may also be implemented as part of a rack server system 2124. In addition, it may be implemented in a personal computer such as a laptop computer 2122. Alternatively, components from computing device 2100 may be combined with other components in a mobile device (not shown), such as device 2150.

Each of such devices may contain one or more of computing device 2100, 2150, and an entire system may be made up of multiple computing devices 2100, 2150 communicating with each other.

Computing device 2150 includes a processor 2152, memory 2164, an input/output device such as a display 2154, a communication interface 2166, and a transceiver 2168, among other components. The device 2150 may also be provided with a storage device, such as a micro-drive or other device, to provide additional storage. Each of the components 2150, 2152, 2164, 2154, 2166, and 2168, are interconnected using various buses, and several of the components may be mounted on a common motherboard or in other manners as appropriate.

The processor 2152 can execute instructions within the computing device 2150, including instructions stored in the memory 2164. The processor may be implemented as a chipset of chips that include separate and multiple analog and digital processors. The processor may provide, for example, for coordination of the other components of the device 2150, such as control of user interfaces, applications run by device 2150, and wireless communication by device 2150.

Processor 2152 may communicate with a user through control interface 2158 and display interface 2156 coupled to a display 2154. The display 2154 may be, for example, a TFT LCD (Thin-Film-Transistor Liquid Crystal Display) or an OLED (Organic Light Emitting Diode) display, or other appropriate display technology. The display interface 2156 may comprise appropriate circuitry for driving the display 2154 to present graphical and other information to a user. The control interface 2158 may receive commands from a user and convert them for submission to the processor 2152. In addition, an external interface 2162 may be provided in communication with processor 2152, to enable near area communication of device 2150 with other devices. External interface 2162 may provide, for example, for wired communication in some implementations, or for wireless communication in other implementations, including multiple interfaces may also be used.

The memory 2164 stores information within the computing device 2150. The memory 2164 can be implemented as one or more of a computer-readable medium or media, a volatile memory unit or units, or a non-volatile memory unit or units. Expansion memory 2174 may also be provided and connected to device 2150 through expansion interface 2172, which may include for example, a SIMM (Single In Line Memory Module) card interface. Such expansion memory 2174 may provide extra storage space for device 2150 or may also store applications or other information for device 2150. Specifically, expansion memory 2174 may include instructions to carry out or supplement the processes described above and may include secure information also. Thus, for example, expansion memory 2174 may be provide as a security module for device 2150 and may be programmed with instructions that permit secure use of device 2150. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, performs one or more methods such as those described above. The information carrier is a computer- or machine-readable medium, such as the memory 2164, expansion memory 2174, or memory on processor 2152, that may be received, for example, over transceiver 2168 or external interface 2162.

Device 2150 may communicate wirelessly through communication interface 2166, which may include digital signal processing circuitry where necessary. Communication interface 2166 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 2168. In addition, short-range communication may occur, such as using a Bluetooth, Wi-Fi, or other such transceiver (not shown). In addition, GPS (Global Positioning system) receiver module 2170 may provide additional navigation- and location-related wireless data to device 2150, which may be used as appropriate by applications running on device 2150.

Device 2150 may also communicate audibly using audio codec 2160, which may receive spoken information from a user and convert it to usable digital information. Audio codec 2160 may likewise generate audible sound for a user, such as through a speaker (e.g., in a handset of device 2150). Such sound may include sound from voice telephone calls, may include recorded sound (e.g., voice messages, music files, etc.) and may also include sound generated by applications operating on device 2150.

The computing device 2150 may be implemented in a number of different forms, as shown in the figure. For example, it may be implemented as a cellular telephone 2160. It may also be implemented as part of a smart phone 2182, personal digital assistant, a computer tablet, or other similar mobile device.

Thus, various implementations of the systems and techniques described here can be realized in digital electronic circuitry, integrated circuitry, especially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse, joystick, trackball, or similar device) by which the user can provide input to the computer. Other kinds of devices can be used to provide for interaction with a user as well, for example; feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system (e.g., computing device 2100 and/or 2150) that includes a back end component (e.g., as a data server, slot accounting system, player tracking system, or similar), or that includes a middleware component (e.g., an application server), or that includes a front end component (e.g., a user application computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include user applications and servers. A user application and server are generally remote from each other and typically interact through a communication network. The relationship of user application and server arise by virtue of computer programs running on the respective computers and having a user application-server relationship to each other.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A system for generating artificial intelligence-driven user interface cards comprising:
a first user device having a screen, a memory storing non-transitory machine executable code, and a processor configured to execute the machine executable code, the machine executable code configured to:
modify a smart card bundle to be compatible with the first user device, the smart card bundle comprising a first set of display elements and a first set of context data, the first set of display elements using one or more functions provided by the user application and the first set of context data responsive to a first request by a user;
predict user preferences based on analysis of user information, and to configure the smart card bundle based on the prediction; and
add a second set of display elements and a second set of context data to the smart card bundle, the second set of display elements using a function not provided by the user application.

2. The system of claim 1 wherein the user information is selected from one or more of the following: user account information, user preferences, prior user selections, user input, user web browser history, user communication, or auxiliary metadata.

3. The system of claim 1 wherein the first set of display elements comprises an interactive prompt to the user suggesting additional user action.

4. The system of claim 1 further comprising a backend server, and the first set of display elements includes a display element that is periodically updated with data from the backend server, the data being streamed from the backend server to the smart card bundle.

5. The system of claim 1 wherein the second set of display elements are configured to communicate with a second user device.

6. The system of claim 1 wherein the machine executable code is further configured to add a third set of display elements and a third set of context data to the smart card bundle based on a second request by the user, wherein the third set of context data is responsive to the first request and the second request.

7. A method for generating artificial intelligence-driven user interface cards comprising the steps of:
receiving a first user request from a user application running on a user device;
compiling a smart card bundle comprising a first set of display elements and a second set of display elements, the first set of display elements using one or more functions provided by the user application, the second set of display elements using a function not provided by the user application;
predicting user preferences based on analysis of user information;
configuring the smart card bundle based on the prediction; and
displaying the first and second set of display elements on a screen of the user device.

8. The method of claim 7 wherein the user information is selected from one or more of the following: user account information, user preferences, prior user selections, user input, user web browser history, user communication, or auxiliary metadata.

9. The method of claim 7 wherein the smart card bundle further comprises a first set of context data, the first set of context data responsive to the first user request.

10. The method of claim 9 further comprising the steps of receiving a second user request from the user application, updating the smart card bundle with a second set of context data, the second set of context data responsive to the first user request and the second user request, and configuring the smart card bundle based on the prediction and the second user request.

11. The method of claim 9 further comprising the step of updating the first set of context data with new information streamed from a backend server.

12. The method of claim 7 wherein the smart card bundle further comprises an interactive prompt to a user suggesting additional action, the interactive prompt configured based on the prediction.

13. The method of claim 7 wherein configuring the smart card bundle comprises performing one or more of the following actions: adding a display element, removing a display element, resize a display element, or reorder two or more display elements.

14. A system for generating artificial intelligence-driven user interface cards comprising:
a first user device having a screen, a memory storing a non-transitory machine executable code, and a processor configured to execute the machine executable code, the machine executable code configured to:
process a smart card bundle into a first smart card for display on the first screen, the smart card bundle comprising a set of display elements and a set of context data;
render the set of display elements on the first smart card using a function not provided by the first user device; and
update the context data with data from a second user device.

15. The system of claim 14 further comprising:
a second smart card processed from the smart card bundle by the second user device;
a third smart card processed from the smart card bundle by a third user device;
wherein the context data on the first user device is updated with data from the second and third smart card.

16. The system of claim 15 wherein the first, second, and third smart cards send data to each other in a peer-to-peer fashion, and the first smart card is elected as a host.

17. The system of claim 14 wherein data from the second user device is routed from the second user device to a backend server, then from the backend server to the first user device.
